(19) United States
(12) Patent Application Publication
(10) Pub. No.: US 2016/0160082 A1
(43) Pub. Date: Jun. 9, 2016

(54) PRINT QUALITY OF POLYMERIC SURFACES WITH AMPHIPHILIC PROTEIN COATING

(71) Applicant: E I DU PONT DE NEMOURS AND COMPANY, Wilmington, DE (US)

(72) Inventors: ANURADHA MISRA, Kanpur (IN); RAHUL MISRA, Kanpur (IN); MANOHAR REDDY ESUKAPALLI, Andhra Pradesh (IN)

(21) Appl. No.: 14/742,747

(22) Filed: Jun. 18, 2015

Related U.S. Application Data
(60) Provisional application No. 62/013,801, filed on Jun. 18, 2014.

(51) Int. Cl. C09D 189/00; A41D 31/02; B41J 3/407

(52) U.S. Cl. CPC C09D 189/00; B41J 3/4078; A41D 31/02

(57) ABSTRACT

This Invention relates to an inkjet printable article of polymeric surface coated with an amphiphilic protein, such as a hydrophobin, to enhance the quality of images printed thereon and to a method of coating of the polymeric surface with the amphiphilic protein with a proviso that the water contact angle of the polymeric surface ≧80° at 25° C. The coated amphiphilic protein functions as an “ink receiving layer”.

### FIELD OF INVENTION

This invention relates to the field of inkjet printing. More specially, it relates to an inkjet printable article comprising a polymeric surface coated with an amphiphilic protein, such as a hydrophobin and the method of manufacture thereof.

### BACKGROUND

Polymeric surface, such as polyolefins, fluoropolymers, or the like demonstrate challenges when used for inkjet printing applications, due to reasons such as poor surface wettability, inferior ink absorption, slow drying of ink on the polymeric surface, uncontrolled lateral flow of ink droplets etc.

In order to obtain high quality inkjet printing on polymeric surface, an optimum balance of absorption of water or other organic solvents, without excessive lateral flow vis-a-vis water or solvent resistance of the polymeric surface is required.

One of the known methods to overcome such challenges and to impart said balance is to apply a coating of an “ink receiving layer” on the polymeric surface. The use of polypeptide as an “ink receiving layer” is reported in prior art. As an “ink receiving layer”, polypeptide may form a hydrogel layer that absorbs ink, holds it and then aids formation of a stable print image on the polymeric surface.

The polypeptide “ink receiving layers” commonly known are gelatin, casein, albumin, or their respective compositions, because of their properties to absorb water, swell quickly at ambient condition, while maintaining the physical integrity of the layer. U.S. Pat. Nos. 4,649,064; 5,474,843; 5,656,378, and EP patent 7,019,02 described gelatin and various gelatin compositions as “ink receiving layer” for polymeric surfaces such as polyesters, polyamides, polyimides, polycarbonates, polyacetals, poly(vinylchloride)s, polyethers, polyolefins, polyolefins coated paper etc. However, gelatin or gelatin compositions are used as “ink receiving layer”, the greatest disadvantage of gelatin as an “ink receiving layer” is that the ink droplets sprayed on to create the image are susceptible to spread and smudge.

A further disadvantages of application of gelatin or gelatin compositions as “ink receiving layer” are, curling of the coated surface, brittleness of the ink receiving layer, resulting in undesirable effects in print quality and aesthetic aspects.

Thus the need was felt to develop an ecofriendly “ink receiving layer” for improvement of quality of print image on polymeric surfaces with optimal ink absorption, resulting in minimal or no effect of the surface such as curling, brittleness, in additional surface having improved smudge resistance and light fastness of the printed article etc.

Coatings of amphiphilic protein such as, hydrophobin on various surfaces including polymeric surfaces are disclosed in U.S. Pat. Nos. 7,241,734; 7,476,537.

The present invention provides an inkjet printable polymeric surface using amphiphilic protein as an “ink receiving layer” on the polymeric surface which overcomes the drawbacks of ink jet printing over polymeric surfaces.

### SUMMARY OF THE INVENTION

Provided herein is an inkjet printable article, wherein the article comprises a polymeric surface, coated on at least one side by an amphiphilic protein. The amphiphilic protein could be for example a hydrophobin and the polymeric surface has water contact angle ≧80° at 25° C.

In one aspect is described a method of coating a polymeric surface with an amphiphilic protein comprising the steps:
a) providing an aqueous solution comprising an amphiphilic protein;
b) contacting the solution of (a) with a suitable polymeric surface at ambit temperature;
c) drying the article resulting from step (b) at ambient temperature till a constant weight is obtained; and
d) treating the article resulting from step (c) by heating at a temperature in the range of about 60° C. and about 120° C. for duration of approximately 1 min to 120 min.

The protein coating so achieved over the polymeric surface functions as an ‘ink receiving layer”, there by rendering the polymeric surface amenable to ink jet printing with desirable end results such as, stability of print images, smudge resistance etc.

### BRIEF DESCRIPTION OF DRAWINGS

Other advantages, characteristics and details of the invention are explained in the detailed description of the invention below made with reference to the accompanying drawings and in which:

FIG. 1: Effect of submerging print images in water—(1a) printed Tyvek® 1048A (CE-1), (1b) printed Tyvek® 1048A coated with BSA (CE-2) and, (1c) printed Tyvek® 1048A coated with hyrodrophobin class II (E-3).

FIG. 2: Effect of weathering on print images—(2a) printed Tyvek® 1048A (CE-1), before weathering; (2b) printed Tyvek® 1048A (CE-1), after weathering; (2c) printed Tyvek® 1048A coated with hydrophobin class II (E-3), before weathering; (2d) printed Tyvek® 1048A coated with hydrophobin class II (E-3), after weathering.

FIG. 3: Line width of print image.

FIG. 4: Spreading of border of print image ‘I’ for inkjet printable articles, (4a) Tyvek® 1048A (CE-1) and (4b) Tyvek® 1048A coated with hydrophobin class II (E-3).

FIG. 5: Hunter L*, a*, b* color scale.

FIG. 6: Penetration of ink through polymeric surface, (6a) Tyvek® 1048A (CE-1), (6b) Tyvek® 1048A coated with hydrophobin class II (E-3)

### DETAILED DESCRIPTION OF INVENTION

The present invention discloses an inkjet printable article prepared by coating a polymeric surface with an amphiphilic protein such as a hydrophobin to form an amphiphilic protein layer on the polymeric surface with a proviso that the polymeric surface has water contact angle ≧80° at 25° C.

The present invention further features a method of coating a polymeric surface with an aqueous composition comprising at least one amphiphilic protein, such as a hydrophobin which function as an “ink receiving layer” after drying and heat treatment.

Polymeric surface coated with the amphiphilic protein as “ink receiving layer” visually do not exhibit any curling and can be printed by inkjet printing method to yield high quality print images.

In one aspect the process involves, printing with an aqueous based ink composition comprises carbon black as a colorant. The printed images are water resistant, and have improved weathering characteristics.

The term “polymeric surface” as used herein, refers to a membrane, film, tape, and fabric made of thermoplastic polymers.

In this invention, the term “membrane” refers to a polymeric surface of thickness ranges between about 20 micron and about 100 micron with porosity ranges between 40% and 85% by volume with respect to the total volume of the polymeric surface.

The term “film” in the present invention refers to a polymeric surface of thickness ranges between about 100 micron and about 300 micron with porosity ranges between 40% and 85% by volume with respect to the total volume of the polymeric surface.

In this invention, the term “tape” is defined as a film containing an adhesive layer on one side of it.

The term “fabric” refers to a cloth like surface made from polymer fibers by weaving, knitting, or by heat fusion under pressure.

The term “drying or dried” as used herein, refers to the processes of removal of water/moisture from the protein solution by methods such as evaporation of water/moisture from the polymeric surface.

The term “ink receiving layer” refers to a coating, able to physically absorb or chemically bind ink and aids in formation of print image.

The term “adhesive layer” used herein refers a coating of a substance used for sticking objects or materials together.

The term “amphiphilic” used herein, refers to a compound that possess both hydrophilic and hydrophobic segments in the chemical structure.

“An aqueous based ink” refers to an ink composed of an aqueous carrier medium. An aqueous carrier medium is composed of water or a mixture of water and one or more water soluble organic solvents.

“Colorant” is meant to encompass pigments, dyes or combinations thereof and the like used in an aqueous based ink composition.

“Porosity” refers to the presence of interconnecting and/or non-interconnecting pores, voids, capillaries or the like in the polymeric surface.

The terms “hydrophilic” or“hydrophilicity” as used herein, refer to substrates that have a good affinity for water, and therefore tend to bind or form attractions to water, and may readily combine with water.

The terms “hydrophobic” or “hydrophobicity” as used herein, refer to substrates that have a poor affinity for water, and therefore tend not to bind, hold or readily combine with water. In some instances hydrophobic substrates may actually repel water.

The words “print image” or ““print impressions” have been used interchangeably to indicate alphabets/numbers/symbols/drawings/charts/or any impression created on the polymer surface/inkjet printable material or matrix by the ink-jet printer or device etc.

The term “line width” as used herein, refers to average width of the border or edge of a print image printed on polymeric surfaces.

The amphiphilic protein solutions that are used to prepare the amphiphilic protein layer on polymeric surface disclosed herein comprises a hydrophobin in water, which is capable of self-assembly at a hydrophilic-hydrophobic interface, and having the general formula (I):

(Y₁)ₙ-B₁-(X₁)ₐ-B₂-(X₂)_{b}-B₃-(X₃)_{c}-B₄-(X₄)_{d}-B₅-(X₅)ₑ-B₆-(X₆)_{f}-B₇-(X₇)_{g}-B₈-(Y₂)ₘ (I)

wherein: m and n can be independently 0 to 2000; B1, B2, B3, B4, B5, B6, B7 and B8 can be each independently amino acids selected from cysteine (Cys), leucine (Leu), alanine (Ala), proline (Pro), serine (Ser), threonine (Thr), methionine (Met) or glycine (Gly), wherein at least 6 of the residues B1 through B8 are Cys; X1, X2, X3, X4, X5, X6, X7, Y1 and Y2 each independently represent any amino acid; a can be 1 to 50; b can be 0 to 5; c can be 1 to 100; d can be 1 to 100; e can be 1 to 50; f can be 0 to 5; and g can be 1 to 100.

A suitable hydrophobin can have a sequence of between 40 and 120 amino acids in the hydrophobin core. The hydrophobin can have a sequence of between 45 and 100 amino acids in the hydrophobin core. The hydrophobin may have a sequence of between 50 and 90 amino acids, preferably 50 to 75, or 55 to 65 amino acids in the hydrophobin core.

The term “the hydrophobin core” means the amino acid sequence beginning with the residue B1 and terminating with the residue B8.

In the formula (I), Y2 is optional, and therefore in some embodiments “m” can be 0, or alternatively can be any integer up to 500.

In the formula (I), Y1 is optional, and therefore in some embodiments “n” can be 0, or alternatively can any integer up to 500.

In the formula (I), in some embodiments, “a” can be any integer from 3 to 25, or alternatively any integer from 5 to 15.

In the formula (I), X2 is optional, but can be present in some embodiments, and therefore “b” can alternatively be 0, 1, or 2. Preferably b is 0.

In the formula (I), in some embodiments, “c” can be any integer from 5 to 50, or alternatively from 5 to 40.

In the formula (I), in some embodiments, “d” can be any integer from 2 to 35, or alternatively from 4 to 23.

In the formula (I), in some embodiments, “e” can be any integer from 2 to 15, or alternatively from 5 to 12.

In the formula (I), X6 is optional, but can be present in some embodiments, therefore “f” can alternatively be 0, 1 or 2.

In the formula (I), in some embodiments, “g” can be any integer from 3 to 35, or alternatively from 6 to 21.

In this invention, hydrophobins suitable for use can alternatively have the general formula (II):

(Y1)n-B1-(X1)a-B2-(X2)b-B3-(X3)c-B4-(X4)d-B5-(X5)e-B6-(X6)f-B7-(X7)g-B8- (Y2)m (II)

wherein: Y1, Y2 and X1 through X7, are as defined above for formula (I); “m” and “n” can be independently 0 to 20; B1, B2, B3, B4, B5, B6, B7 and B8 can each independently be an amino acid selected from the group consisting of Cys, Leu, Ala, Pro, Ser, Thr, Met or Gly, wherein at least 7 of the residues B1 through B8 are Cys; “a” can be any integer from 3 to 25; “b” can be 0, 1 or 2; “c” can be any integer from 5 to 50; “d” can be any integer from 2 to 35; “e” can be any integer from 2 to 15; “f” can be 0, 1 or 2; and “g” can be any integer from 3 to 35.

In this invention, hydrophobins suitable for use can alternatively have the general formula (III):

(Y1)n-B1-(X1)a-B2-B3-(X3)c-B4-(X4)d-B5-(X5)e-B6-B7-(X7)g-B8-(Y2)m (III)

wherein: Y1, Y2 and X1, X3, X4, X5, and X7, are as defined above for formula (I); m and n can each independently be any integer from 0 to 20; B1, B2, B3, B4, B5, B6, B7 and B8 can each independently be an amino acid selected from the group consisting of Cys, Leu, Ala, Pro, Ser, Thr, Met or Gly, wherein at least 7 of the residues B1 through B8 are Cys; “a” can be an integer from 5 to 15; “c” can be an integer from 5 to 40; “d” can be an integer 4 to 23; “e” can be an integer from 5 to 12; and “g” can be an integer from 6 to 21.

In the formulae (I), (II) and (III), when 6 or 7 of the residues B1 through B8 can be Cys, it is preferred that the residues B3 through B7 are Cys.

In the formulae (I), (II) and (III), when 7 of the residues B1 through B8 can be Cys, in some embodiments: (a) B1 and B3 through B8 can be Cys and B2 can be other than Cys; (b) B1 through B7 can be Cys and B8 can be other than Cys, (c) B1 can be other than Cys and B2 through B8 can be Cys. When 7 of the residues B1 through B8 are Cys, the other residue can be Ser, Pro or Leu. In some embodiments, B1 and B3 through B8 can be Cys and B2 can be Ser. In some embodiments, B1 through B7 can be Cys and B8 can be Leu. In further embodiments, B1 can be Pro and B2 through B8 can be Cys.

The cysteine residues of the hydrophobins used in the invention can be present in the reduced (that is, “—S—H”) form or, alternatively, can form disulfide (—S—S—) bridges with one another in any possible combination. In some embodiments, when all 8 of the residues B1 through B8 are Cys, disulfide bridges can be formed between one or more (preferably at least 2, more preferably at least 3, most preferably all 4) of the following pairs of cysteine residues: B1 and B6; B2 and B5; B3 and B4; B7 and B8. In other embodiments, when all 8 of the residues B1 through B8 are Cys, disulfide bridges can be formed between one or more (at least 2, or at least 3, or all 4) of the following pairs of cysteine residues: B1 and B2; B3 and B4; B5 and B6; B7 and B8.

Examples of specific hydrophobins useful in the present invention include those described and exemplified in the following publications: Linder et al., FEMS Microbiology Rev. 2005, 29, 877-896; Kubicek et al., BMC Evolutionary Biology, 2008, 8, 4; Sunde et al., Micron, 2008, 39, 773-784; Wessels, Adv. Micr. Physiol. 1997, 38, 1-45; Wösten, Annu. Rev. Microbiol. 2001, 55, 625-646; Hektor and Scholtmeijer, Curr. Opin. Biotech. 2005, 16, 434-439; Szilvay et al., Biochemistry, 2007, 46, 2345-2354; Kisko et al. Langmuir, 2009, 25, 1612-1619; Blijdenstein, Soft Matter, 2010, 6, 1799-1808; Wösten et al., EMBO J. 1994, 13, 5848-5854; Hakanpää et al., J. Biol. Chem., 2004, 279, 534-539; Wang et al.; Protein Sci., 2004, 13, 810-821; De Vocht et al., Biophys. J. 1998, 74, 2059-2068; Askolin et al., Biomacromolecules 2006, 7, 1295-1301; Cox et al.; Langmuir, 2007, 23, 7995-8002; Linder et al., Biomacromolecules 2001, 2, 511-517; Kallio et al. J. Biol. Chem., 2007, 282, 28733-28739; Scholtmeijer et al., Appl. Microbiol. Biotechnol., 2001, 56, 1-8; Lumsdon et al., Colloids & Surfaces B: Biointerfaces, 2005, 44, 172-178; Palomo et al., Biomacromolecules 2003, 4, 204-210; Kirkland and Keyhani, J. Ind. Microbiol. Biotechnol., Jul. 17, 2010 (e-publication); Stubner et al., Int. J. Food Microbiol., 30 Jun. 2010 (epublication); Laaksonen et al. Langmuir, 2009, 25, 5185-5192; Kwan et al. J. Mol. Biol. 2008, 382, 708-720; Yu et al. Microbiology, 2008, 154, 1677-1685; Lahtinen et al. Protein Expr. Purif., 2008, 59, 18-24; Szilvay et al., FEBS Lett., 2007, 5811, 2721-2726; Hakanpää et al., Acta Crystallogr. D. Biol. Crystallogr. 2006, 62, 356-367; Scholtmeijer et al., Appl. Environ. Microbiol., 2002, 68, 1367-1373; Yang et al, BMC Bioinformatics, 2006, 7 Supp.4, S16; WO 01/57066; WO 01/57528; WO 2006/082253; WO 2006/103225; WO 2006/103230; WO 2007/014897; WO 2007/087967; WO 2007/087968; WO 2007/030966; WO 2008/019965; WO 2008/107439; WO 2008/110456; WO 2008/116715; WO 2008/120310; WO 2009/050000; US 2006/0228484; and EP 2042156A; the contents of which are incorporated herein by reference.

Hydrophobins are divided into Classes I and II. Hydrophobins of Classes I (HFB I) and II (HFB II) can be distinguished based on properties such as solubility. As described herein, hydrophobins self-assemble at an interface (e.g., a water/air interface) into amphiphilic interfacial films. The assembled amphiphilic films of Class I hydrophobins are generally re-solubilized only in strong acids (typically those having a pKa of lower than 4, such as formic acid, trifluoroacetic acid etc., whereas those of Class II are soluble in a wider range of solvents.

In one embodiment, suitable hydrophobins for this invention can belong to hydrophobin Class II (HFB II).

Class II hydrophobins can comprise hydrophobins having the above-described self-assembly property at a water/air interface, the assembled amphiphilic films can re-dissolve to a concentration of at least 0.1% (w/w) in an aqueous ethanol solution (60% v/v) at room temperature.

Class II hydrophobins can comprise a hydrophobin (as defined and exemplified herein) having the above-described self-assembly property and in which the region between the residues B3 and B4, i.e. the moiety (X3)c, is predominantly hydrophobic.

Class II hydrophobins can comprise a hydrophobin having the above-described self-assembly property and in which the region between the residues B7 and B8, i.e. the moiety (X7)g, is predominantly hydrophobic.

Class II hydrophobins can comprise hydrophobins having the above-described self-assembly property and in which the region between the residues B3 and B4, i.e. the moiety (X3)c, is predominantly hydrophobic. Class I hydrophobins can comprise hydrophobins having the above-described self-assembly property but in which the region between the residues B3 and B4, i.e. the group (X3)c, is predominantly hydrophilic.

Class II hydrophobins can comprise hydrophobins having the above-described self-assembly property and in which the region between the residues B7 and B8, i.e. the moiety (X7)g, is predominantly hydrophobic.

The relative hydrophobicity/hydrophilicity of the various regions of the hydrophobin protein can be established by comparing the hydropathy pattern of the hydrophobin using the method set out in Kyte and Doolittle, J. Mol. Biol., 1982, 157, 105-132 and in Wessels, Adv. Microbial Physiol. 1997, 38, 1-45. Class II hydrophobins can also be characterized by their conserved sequences.

Class II hydrophobins suitable for this invention can have the general formula (IV):

(Y1)n-B1-(X1)a-B2-B3-(X3)c-B4-(X4)d-B5-(X5)e-B6-B7-(X7)g-B8-(Y2)m (IV)

wherein: Y1, Y2 and X1, X3, X4, X5, and X7, are as defined above for formula (I); “m” and “n” can each independently be any integer from 0 to 200; B1, B2, B3, B4, B5, B6, B7 and B8 are each independently amino acids selected from Cys, Leu, Ala, Ser, Thr, Met or Gly, wherein at least 6 of the residues B1 through B8 are Cys; “a” can be any integer from 6 to 12, or alternatively any integer from 7 to 11; “c” can be any ineger from 8 to 16, or alternatively any integer from 10 to 12; “d” can be any integer from 2 to 20, or alternatively any integer from 4 to 18; “e” can be any integer from 4 to 12, or alternatively any integer from 6 to 10; and “g” can be any integer from 5 to 15, or alternatively any integer from 6 to 12.

Class II hydrophobins suitable for this invention can have the general formula (V):

(Y1)n-B1-(X1)a-B2-B3-(X3)c-B4-(X4)d-B5-(X5)e-B6-B7-(X7)g-B8-(Y2)m (V)

wherein: Y1, Y2 and X1, X3, X4, X5, and X7, are as defined above for formula (IV); “m” and “n” can each independently be any integer from 0 to 10; B1, B2, B3, B4, B5, B6, B7 and B8 can each independently be an amino acid selected from Cys, Leu or Ser, wherein at least 7 of the residues B1 through B8 are Cys; “a” can be any integer from 7 to 11; “c” can be 11; “d” can be any integer from 4 to 18; “e” can be any integer from 6 to 10; and “g” can be any integer from 7 to 10.

In the formulae (IV) and (V) at least 7 of the residues B1 through B8 are Cys, or alternatively all 8 of the residues B1 through B8 are Cys.

In the formulae (IV) and (V), in some embodiments, when 7 of the residues B1 through B8 are Cys, the residues B3 through B7 can be Cys.

In the formulae (IV) and (V), in some embodiments, when 7 of the residues B1 through B8 are Cys: (a) B1 and B3 through B8 can be Cys and B2 can be other than Cys; (b) B1 through B7 can be Cys and B8 can be other than Cys, or (c) B1 can be other than Cys and B2 through B8 can be Cys. In some embodiments, when 7 of the residues B1 through B8 are Cys, the other residue can be Ser, Pro or Leu. In some embodiments, B1 and B3 through B8 can be Cys and B2 can be Ser. In some embodiments, B1 through B7 can be Cys and B8 can be Leu. In some embodiments, B1 can be Pro and B2 through B8 can be Cys.

In the formulae (IV) and (V), in some embodiments, the group (X3)c can comprise the sequence motif ZZXZ, wherein Z can be an aliphatic amino acid; and X can be any amino acid.

In some embodiments, the group (X3)c can comprise the sequence motif selected from the group consisting of LLXV, ILXV, ILXL, VLXL and VLXV, wherein “L” is leucine, “V” is valine, and “1” is isoleucine. In some embodiments, the group (X3)c can comprise the sequence motif VLXV.

In the formulae (IV) and (V), in some embodiments, the group (X3)c can comprise the sequence motif ZZXZZXZ, wherein Z can be an aliphatic amino acid; and X can be any amino acid.

In some embodiments, the group (X3)c can comprise the sequence motif VLZVZXL, wherein Z can be an aliphatic amino acid; and X can be any amino acid.

The hydrophobin suitable for the present invention can be obtained from a diverse array of fungi such as Ascomycota, Cladosporium (particularly C. fulvum), Ophistoma (particularly O. ulmi), Cryphonectria (particularly C. parasitica), Trichoderma (particularly T. harzianum, T. longibrichiatum, T. asperellum, T. Koningiopsis, T. aggressivum, T. stromaticum or T. reesei), Gibberella (particularly G. moniliformis), Neurospora (particularly N. crassa), Maganaporthe (particularly M. grisea) or Hypocrea (particularly H. jecorina, H. atroviridis, H. virens or H lixii).

The suitable hydrophobin for the present invention can be obtained from fungi of the genus Trichoderma (particularly T. harzianum, T. longibrichiatum, T. asperellum, T. Koningiopsis, T. aggressivum, T. stromaticum or T. reesei). Alternatively, the hydrophobin can be obtained from fungi of the species T. reesei. Further, DNA sequences of many hydrophobins from various microorganisms are available through GENBANK (Maryland, USA). Such DNA sequences can be expressed in a suitable microbial host (by methods well known in the art) and the desired hydrophobin can be produced. Any of these hydrophobins can be suitable for application in the invention.

In addition to hydrophobins obtained as described above, hydrophobin derivatives or hydrophobin-like materials comprising chemically modified or genetically modified hydrophobins can also be used in the present invention. Examples of such hydrophobin modifications include glycosylation, acetylation or by chemical cross-linking for example with glutaraldehyde or by cross-linking with a polysaccharide such as heparin. Hydrophobin-like proteins have the self-assembly property of the original hydrophobin at hydrophilic or hydrophobic interfaces into amphipathic coatings. For the purposes of this invention, as used herein, the term “hydrophobin” refers to both the naturally obtained hydrophobins as well as those either genetically or chemically modified hydrophobins.

Hydrophobin protein of the present invention may be exist in dimer and tetramer in the solution and obtained from an agglomerated or aggregated structure of hydrophobin. Hydrophobin protein of the present invention may exist in the solution as agglomerated or aggregated structure also. Hydrophobin protein compositions of the present invention are obtained from agglomerated or aggregated structure of hydrophobins according to processes described herein below. Hydrophobin protein compositions of the present invention can be in the form of a solution, dispersion, emulsion or suspension in an aqueous medium, wherein the hydrophobin protein consist essentially of hydrophobin dimers, tetramers and agglomerated or aggregated structure of Class II hydrophobin.

Suitable hydrophobin protein composition for this invention can belong to an aqueous solution.

A suitable concentration of aqueous hydrophobin protein solution to be used for a coating of the present invention can vary depending on the end use application of the coated article, on the nature of the polymeric surface and on the amount of hydrophilicity to impart on the polymeric surface. One of ordinary skill in the art, informed by the disclosures of the present application, can determine what concentration of aqueous hydrophobin protein composition would be suitable for use and to impart desired level of hydrophilicity on the polymeric surface. For example, the amount of the hydrophobin protein to be included in the hydrophobin composition used to coat a polymeric surface can be determined by the person skilled in the art based on the structure and dimensions of hydrophobin proteins in accordance with the nature of the surface to be coated.

In one embodiment, aqueous composition of hydrophobin protein is a solution of hydrophobin protein in water in the concentration range between about 10 ppm and about 1000 ppm.

In one embodiment, aqueous solution of Class II hydrophobin may further comprise suitable UV stabilizer, light fastness imparting agent, dye mordant, thermal stabilizer, biocide, or a combinations thereof.

The additives can be added in the aqueous composition in a range of 0 to 60% by weight based on the amphiphilic protein content in the aqueous composition.

Hydrophobin protein suitable for the present invention can be obtained by first preparing an aqueous composition comprising at least the hydrophobin protein, and then processing this composition using a method that break down the agglomerated or aggregated structure of hydrophobin to produces oligomeric, dimers and tetramers of hydrophobin protein. Such methods of break down the agglomerated or aggregated structure of hydrophobin include, for example: sonication, high speed shearing etc.

Sonication, as practiced herein is a process that uses a sonicator to apply vibration to the aqueous hydrophobin protein composition, and thereby separate the protein agglomerates or aggregates therein.

High speed shearing, as practiced herein is a process that uses an impeller rotating at high speed to apply strong shearing force to the aqueous hydrophobin protein composition, and thereby separate the protein agglomerate or aggregate therein.

Hydrophobin protein compositions thus obtained in water can remain stable for a time sufficient to use said compositions for coating applications, for example 7 days or more, or 14 days or more. However, in the present invention, the aqueous hydrophobin protein composition is used for coating the polymeric surface within 5-10 min of sonication.

In one embodiment of the present invention, the polymeric surface used for coatings by aqueous amphiphilic protein solution comprises a membrane, film, tape, woven fabric, non-woven fabric or the like.

The polymeric surface described herein above may be prepared from any suitable thermoplastic polymeric materials.

In one embodiment the polymeric surface may have a water contact angle in the range between 80° and 140° at 25° C., alternatively the polymeric surface may have a water contact angle in the range between 100° and 130° at 25° C.

The polymeric surface may have porosity. The amount of porosity may range between 40% and 85% of the total volume of the polymeric surface. Alternatively, the amount of porosity may range between 50% and 75% of the total volume of the polymeric surface.

In one embodiment, the polymeric surface includes one or more polyolefin surface selected from the group consisting of high density polyethylene (HDPE), ultrahigh molecular weight polyethylene (UHMPE), linear low density polyethylene (LLDPE), ethylene copolymers, polypropylene (PP), and propylene copolymers and the like.

In the present invention, the polymeric surface used can preferably be a fabric, such as a non-woven fabric or a woven fabric.

Suitable polymeric surface for this invention can belong to a non-woven fabric. Non-woven fabric used herein, are sheet or web like structure. Filaments or fibers of suitable polymers can be first spun from their melts or from their solutions and then bonded together by heat, pressure or a combination thereof in presence or absence of a binder to form the non-woven fabric. The non-woven fabric may be a point bonded fabric or area bonded fabric.

The non-woven fabric spun bonded from high density polyethylene (HDPE), Tyvek®, available from E.I. du Pont de Nemours and Company, may be one of the suitable polymeric surfaces in the present invention. HDPE non-directional fibers are first spun and then bonded together by combination of heat and pressure, without a binder. Examples of suitable Tyvek® in the present invention may be selected from Tyvek® 1048A, Tyvek® 1025A, Tyvek® 1056B, Tyvek® 1059B, Tyvek® 1073B, Tyvek® 1073D, Tyvek® 1079D, Tyvek® 1443R, Tyvek® 1622E, Tyvek® 2FS™.

The non-woven fabric made from spun bonded polypropylene fiber, Typar® available from E.I. du Pont de Nemours and Company can be an alternative polymeric surface in the present invention.

The non-woven fabric may be alternatively made from spun bonded poly(trimethyleneterephthalate) fiber, Sorona® available from E.I. du Pont de Nemours and Company.

Non-woven fabrics made from spun bonded multi-component fibers can also be used as polymeric surface.

Non-woven fabrics supported with a backing layer, wherein the backing layer may be a polymer film, tape, woven fabric, non-woven fabric or the like adhered with the non-woven fabric by binders or application of heat or application of heat and pressure may also be selected as polymeric surface.

Woven fabrics used herein have web or sheet like structure, made from long continuous polymer fibers by the interlacing of warp (0°) fibers and weft (90°) fibers in a regular pattern.

Woven fabric used herein may be made of aromatic polyamides and derived from the condensation reaction of terephthalic acid or terephthaloyl chloride with (meta or para) phenylene diamine or the like. Aromatic polyamide used may be Kevlar® or Nomex® available from E.I. du Pont de Nemours and Company. Suitable examples of Nomex® which can be used as polymeric surface are selected from Nomex® type 410, Nomex® type 411, Nomex® type 414, Nomex® type 418, Nomex® type 419, Nomex® type E-56, Nomex® type E-196 or the like.

Suitable polymeric surface may be a film made by conventional polymer processing techniques, wherein the film may be single layered or multi-layered essentially consist of linear low density polyethylene (LLDPE), high density polyethylene (HDPE), ultrahigh molecular weight polyethylene (UHMWPE), ethylene copolymers, polypropylene (PP), propylene copolymers, or the like. Multi-layered film may be made by combination of polymer layers selected from same polymer or different polymers mentioned herein above. The film may have the water contact angle ranges between about 80° and about 140° at 25° C. Alternatively, the film may have the water contact angle ranges between about 100° and about 130° at 25° C. The film may have the porosity ranges between about 40% and about 85% of the total volume of the film. Alternatively, the film may have the porosity ranges between about 50% and about 75% of the total volume of the film.

Suitable polymeric surface may be a tape made by conventional polymer processing techniques, wherein the tape essentially consist of linear low density polyethylene (LLDPE), high density polyethylene (HDPE), ultrahigh molecular weight polyethylene (UHMWPE), ethylene copolymers, polypropylene (PP), propylene copolymers, or the like, wherein an adhesive layer is coated one surface of the tape. The surface of the tape without any adhesive layer may have the water contact angle ranges between about 80° and about 140° at 25° C. Alternatively, the surface of the tape without any adhesive layer may have the water contact angle ranges between about 100° and about 130° at 25° C. The tape may have the porosity ranges between about 40% and about 85% of the total volume of the tape. Alternatively, the tape may have the porosity ranges between about 50% and about 75% of the total volume of the tape.

In one embodiment the polymeric surface described herein above is cleaned with acetone and dried at ambient temperature for 5 to 10 min in air before contacting with aqueous composition of amphiphilic protein.

According to the present invention, the polymeric surface can be coated by contacting the surface with aqueous composition of amphiphilic protein solution. The term “contact or contacting”, as used herein, refers to covering at least a part of the polymeric surface or entire polymeric surface with the aqueous composition comprising amphiphilic protein using roller application, spraying, dip coating, spin coating, or alternatively by immersing the article in the aqueous protein composition.

The polymeric surface may be coated by suitable methods such as movement of a bar or rod or roller over the polymeric surface in an applicator with aqueous composition of amphiphilic protein solution placed on the polymeric surface.

The polymeric surface may alternatively be coated by dipping in aqueous composition of amphiphilic protein solution.

According to the present invention, coating of the polymeric surface with aqueous amphiphilic protein solution can be performed at a temperature range of 1° C. to 45° C. temperature. Alternatively, the temperature range can be from 10° C. to 35° C. In an alternative, the temperature used to coat the polymeric surface with aqueous amphiphilic protein solution is the ambient temperature from 15° C. to 30° C.

The respective temperatures of polymeric surface and the aqueous amphiphilic protein solution before contact need not necessarily be the same.

The present invention provides a process for coating a polymeric surface in parts or entirety by an amphiphilic protein layer.

After the polymeric surface has been coated with aqueous amphiphilic protein solution, the coated surface can be dried. The term “drying or dried” as used herein, refers to the processes of removal of water/moisture from the protein solution by methods such as evaporation of water/moisture from the polymeric surface. The drying can be carried out, for example, at ambient temperatures, or at elevated temperatures or by blowing a stream of gas at ambient temperature or elevated temperature over the polymeric surface to dry the coating. Drying can likewise be carried out under reduced pressure at ambient temperature or elevated temperatures also.

In an embodiment of the present invention, the protein coated polymeric surface is dried at ambient temperature in air till constant weight.

After drying, the amphiphilic protein coated polymeric surface can be subjected to a heat treatment in an oven. In one embodiment, the temperature useful for a heat treatment can be at the temperature range between about 60° C. and about 120° C. Alternatively, the temperature useful for a heat treatment can be between about 80° C. and about 90° C.

The time of heat treatment of amphiphilic protein coated polymeric surface can be in the range between about 1 min and between 120 min.

In one embodiment, the time for heat treatment can be between about 1 min and about 120 min. Alternatively, the time for heat treatment can be between about 2 min and about 30 min.

The article obtained after heat treatment of polymeric surface coated with amphiphilic protein layer is an inkjet printable article.

The weight of the amphiphilic protein layer on the polymeric surface may range for example between about 0.001 g/m² and about 0.50 g/m².

In one embodiment, the weight of the amphiphilic protein layer on the polymeric surface ranges between about 0.002 g/m² and about 0.175 g/m²

Alternatively, the weight of the amphiphilic protein layer on the polymer surface could range between about 0.005 g/m² and about 0.10 g/m².

The amphiphilic protein layer on the polymeric surface of the inkjet printable article may function as an “ink receiving layer” during inkjet printing.

Printing on inkjet printable article can be performed for example by using HP ink jet printer, model 6000, wherein ink composition is an ink based on aqueous medium and comprises carbon black as the colorant.

Ink composition may further comprise of components such as 1, 5 pentanediol, 2-pyrollidone, aliphatic diol, pyridine azo dye, metal nitrate, polycyclic sulfonic acid, substituted phthalocyanine salts, phenylenediamine derivatives, colorants or a combination thereof.

A print image ‘I’ (Font—Angsana New, Font Size—28) is printed on the inkjet printable article to study the print quality on inkjet printable article.

Visual inspection of inkjet printable article and inkjet printable article after printing by inkjet printing method demonstrate no curling of the surface.

The inkjet printable articles prepared herein are shown in Table 1.

The change in hydrophilicity of the polymeric surface coated with amphiphilic protein, such as hydrophobin class II, or bovine serum albumin (BSA), as “ink receiving layer” are determined by measuring the water contact angle (WCA) of the coated polymeric surface compared to the WCA of the polymeric surface without any protein coating. The WCA measurement is known in the relevant art and described in example section along with WCA data in Table 2.

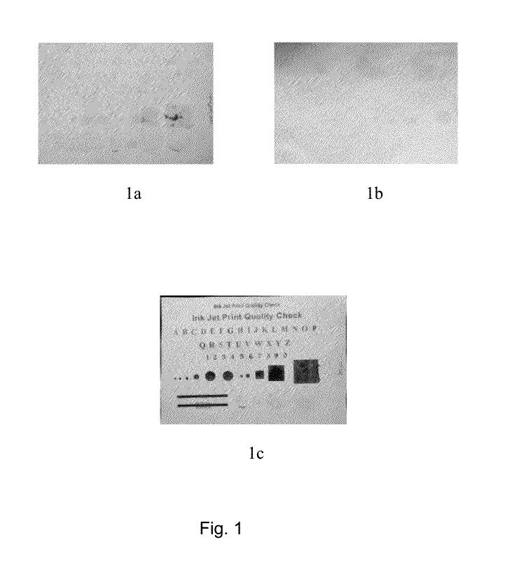

The stability of print images on inkjet printable articles when exposed to water is evaluated for example microscopically after dipping in deionized water for 4 h at ambient temperature. Inkjet printable article with amphiphilic protein layer demonstrate improved stability of print image over BSA coated inkjet printable article (CE-2) and inkjet printable article without any coating (CE-1), FIG. 1.

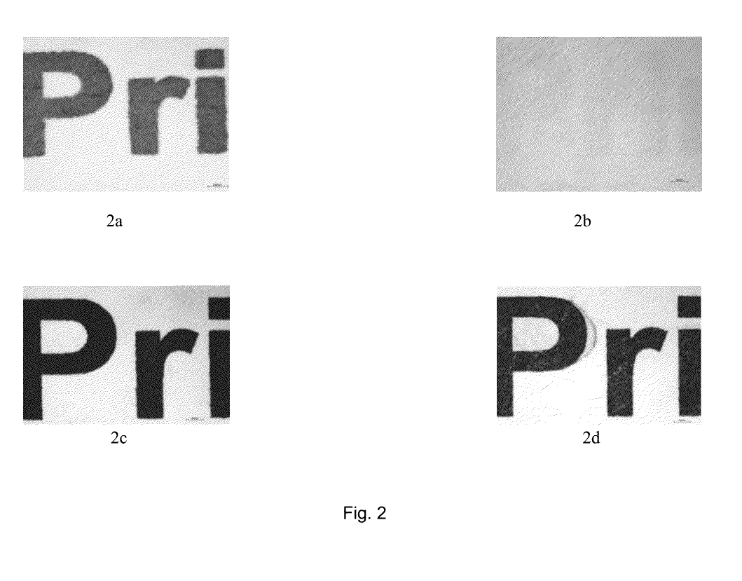

The “weatherability” test of print images on inkjet printable articles is evaluated microscopically following method described in ASTM G 154. The method of “weatherability” test is described in example section in details. Inkjet printable articles coated with amphiphilic protein layer are able to retain the print image after weatherability study, wherein, for inkjet printable article without any coating, the print image disappears after weathering, FIG. 2.

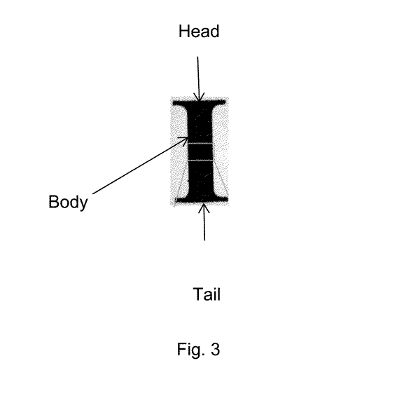

The print quality of the print image on inkjet printable articles (table 1) is further evaluated by measuring the uncontrolled lateral flow of ink when the article is printed using an ink composition. Blurring, smearing, uncontrolled lateral flow of ink on inkjet printable article represents poor smudge resistance. Uncontrolled lateral flow of ink may result in irregular border or edge of the print image impacting the sharpness of the printed image. Measurement of average line width from border of a print image is described in detail in example section, FIG. 3, to evaluate quality of printing on an inkjet printable article. Evaluation of line width of a print image is performed using the print image ‘I’ (Font—Angsana New, Font Size—28) in each case.

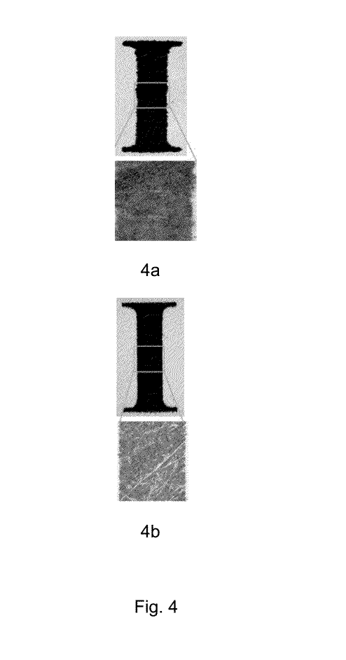

Inkjet printable articles coated with amphiphilic protein layer demonstrates improved quality of image, FIG. 4. Amphiphilic protein layer on polymeric surface, improves print quality as indicated by low spreading of border of the print image, FIG. 4. Uncontrolled lateral flow of ink or irregularities of the image ‘I’ along the border is higher in polymeric surface without any coating, BSA coated polymeric surface, in comparison to amphiphilic protein coated polymeric surface, FIG. 4 and Table 3.

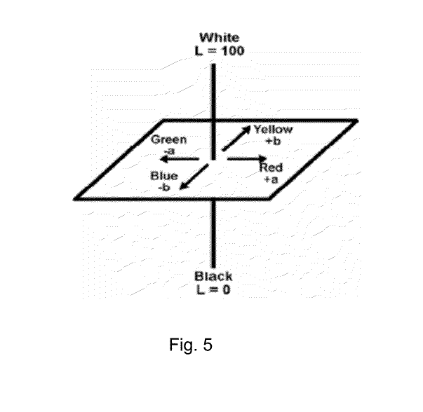

The color measurement of the polymeric surface coated with amphiphic protein layer and polymeric surface without coating of protein layer are determined for example by measuring reflection of light from the respective surfaces as described in Hunter L*, a*, b* scale, FIG. 5. The method of color measurement is known in the relevant art and is provided in the example section herein. The color measurement of inkjet printable articles based on polymeric surface coated with amphiphilic protein layer shows a decrease of ‘L’ value in Hunter L*, a*, b* scale by at least 30, compared with the ‘L’ value of polymeric surface without coating with protein layer, Table 4.

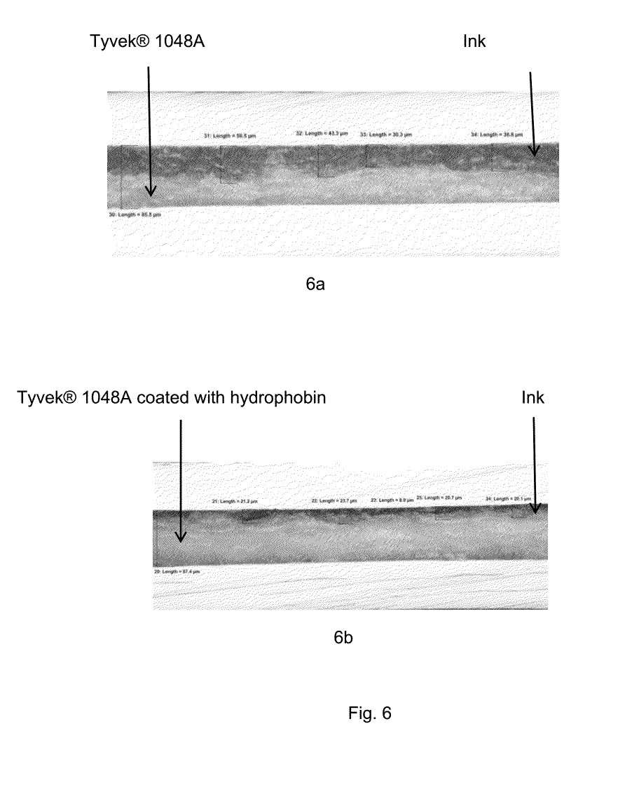

Absorption and spreading of ink inside the pores present in polymeric surface, Tyvek® 1048A results higher ‘L’ value of CE-1 over E-3 where, coating of hydrophobin protein layer on Tyvek® resist penetration of ink inside the pores and assist to hold ink on Tyvek® surface, FIG. 6.

The applications of ink jet printable article as described in the present invention covers printing of documents, print packaging items, labels, bar codes, cloths and garments, exterior decoration or the like.

### EXAMPLES

While the exemplary embodiments have been shown and described, it will be understood by those skilled in the art that various changes in form and details may be made thereto without departing from the spirit and scope of the present disclosure as defined by the appended claims.

The following abbreviations are used in the Examples:

“ppm” is parts per million; “min” is minute(s); “s” is “second; “h” is “hour”; “nm” is nanometer(s); “cm/s” is centimeter per second; “mm/s” is millimeter(s) per second; “ml” is milliliter(s); “WCA” is water contact angle; “cm” is centimeter(s); “dia” is diameter; “mg” is milligram.

### Materials and General Methods

Hydrophobin Class II (HFB II, Activation Associated Protein (ASP)), a natural fungal hydrophobin protein derived from Trichoderma Reesei and obtained from Genencor (A Danisco division) was used.
Bovine Serum Albumin (BSA), A2153 obtained from Sigma Aldrich was used.
Tyvek® 1048A (Dimension—29.7 cm×21 cm) obtained from E.I. du Pont de Nemours and Company was used as polymeric surface.
Water—Commercially available deionized (DI) water was used.
Acetone—Commercially available acetone was used.

Hydrophobin Class II (HFB II, ASP) and Bovine Serum Albumin (BSA) are described as “protein” in the following paragraphs.

### Preparation of Polymeric Surface

Tyvek® 1048A of dimension 29.7 cm×21 cm was cleaned with acetone and dried at ambient temperature for about 5 min.

### Preparation of Protein Solution

Aqueous protein solutions were prepared by adding precalculated amount of a protein in 100 ml of deionized water and the aqueous protein solutions prepared thereby were sonicated in a bath sonicator, Fast Clean Ultrasonic Cleaner (EN—50US, from Life Care Equipments Pvt. Ltd., India) between about 10 and about 12 min with an operating frequency of 33±2 kHz at a temperature of 25° C.

Aqueous protein solutions thus obtained were used for coating Tyvek® 1048A within 5-10 min of sonication.

### Contacting Protein Solution on Tyvek® 1048A

Aqueous protein solutions were coated on at least one side of Tyvek® 1048A using an Automatic Film Applicator (1133N, from Sheen Instruments) following the method described in ASTM D823 Practice C. After cleaning and drying, the Tyvek® 1048A was placed horizontally on the plate of the Automatic Film Applicator and a bar or rod was attached with the Automatic Film Applicator on top of one end of Tyvek® surface. 5-10 ml. of an aqueous protein solution was spread over the Tyvek® surface along the length of the bar or rod and the bar or rod was allowed to move from one end to other end of the Tyvek® surface at a speed of 100 mm/s.

The aqueous solution of protein can be applied at least on one side of Tyvek® surface. When both sides of the Tyvek® surface were coated, one side of the Tyvek® was coated first with the solution, dried by the method described herein below and the other side of the surface was similarly coated thereafter with the solution and dried by a similar processes.

### Drying of Protein Solution from Tyvek® 1048A Surface

Aqueous protein solution contacted on Tyvek® surface was dried in air at ambient temperature till constant weight by evaporating water to form a coating of protein on Tyvek® surface.

### Heat Treatment

Tyvek® surface coated with protein, was heat treated at a temperature range between about 80° C. and about 90° C. for 2 min.

### Effect of Application of Reduced Pressure

To study the effect of heat treatment on print quality of inkjet printable article described herein above, Tyvek® surface coated with protein was further subjected to reduced pressure (100 mm of Hg) in a vacuum chamber. No heat treatment was performed.

### Method of Printing

Printing was performed using inkjet printer (HP Office—6000). The ink composition comprised of colorant carbon black, 1,5-pentanediol, 2-pyrollidone and water.

### Example 1 (E-1)

### Preparation of Inkjet Printable Article by Coating 25 Ppm Aqueous Solution of Hydrophobin Class II on Tyvek® 1048A

The inkjet printable article described herein was made by adding 2.5 mg of hydrophobin class II protein in 100 ml of deionized water to prepare a hydrophobin class II protein solution of 25 ppm wherein the aqueous hydrophobin class II protein solution was sonicated in a bath sonicator, Fast Clean Ultrasonic Cleaner (Model: EN—50US manufactured by Life Care Equipments Pvt. Ltd., India) for 10 min with an operating frequency of 33±2 kHz at a temperature of 25° C.; applying 5 ml of the hydrophobin class II protein solution on at least one cleaned surface of Tyvek® 1048A using Automatic Film Applicator (Model 1133N from Sheen Instruments) following the method described in ASTM D823 Practice C and bar speed of 100 mm/s; allowed the protein solution to dry to form a hydrophobin class II protein layer on Tyvek® 1048A at ambient temperature in air till the resultant Tyvek® 1048A surface coated with hydrophobin attained a constant weight (indicating that it was solvent free). This was followed by heat treatment at a temperature range of about 80° C. and about 90° C. for 2 min.

### Example 2 (E-2)

### Preparation of Inkjet Printable Article by Coating 50 Ppm Aqueous Solution of Hydrophobin Class II on Tyvek® 1048A

The inkjet printable article described herein was made following the method as described in example 1 except that 5 mg of hydrophobin class II protein was added in 100 ml of deionized water to prepare a hydrophobin class II protein solution of 50 ppm.

### Example 3 (E-3)

### Preparation of Inkjet Printable Article by Coating 100 Ppm Aqueous Solution of Hydrophobin Class II on Tyvek® 1048A

The inkjet printable article described herein was made following the method as described in example 1 except that 10 mg of hydrophobin class II protein was added in 100 ml of deionized water to prepare a hydrophobin class II protein solution of 100 ppm.

### Example 4 (E-4)

### Preparation of Inkjet Printable Article by Coating 200 Ppm Aqueous Solution of Hydrophobin Class II on Tyvek® 1048A

The inkjet printable article described herein was made following the method as described in example 1 except that 20 mg of hydrophobin class II protein was added in 100 ml of deionized water to prepare a hydrophobin class II protein solution of 200 ppm.

### Example 5 (E-5)

### Preparation of Inkjet Printable Article by Coating 500 Ppm Aqueous Solution of Hydrophobin Class II on Tyvek® 1048A

The inkjet printable article described herein was made following the method as described in example 1 except that 50 mg of hydrophobin class II protein was added in 100 ml of deionized water to prepare a hydrophobin class II protein solution of 500 ppm.

### Comparative Example 1 (CE-1)

Cleaned and dried Tyvek® 1048A was used as inkjet printable article

### Comparative Example 2 (CE-2)

### Preparation of Inkjet Printable Article by Coating 100 Ppm Aqueous Solution of BSA on Tyvek® 1048A

The inkjet printable article described herein was made following the method as described in example 1 except that 10 mg of BSA protein was added in 100 ml of deionized water to prepare a BSA protein solution of 100 ppm.

### Comparative Example 3 (CE-3)

### Preparation of Inkjet Printable Article by Coating 100 Ppm Aqueous Solution of Hydrophobin II on Tyvek® 1048A and Application of Reduced Pressure

The inkjet printable article described herein was made following the method as described in example 1 except that 10 mg of hydrophobin class II protein was added in 100 ml of deionized water to prepare a hydrophobin protein solution of 100 ppm and heat treatment step was by the step of subjecting the inkjet printable article to conditions of reduced pressure i.e. 100 mm of Hg at ambient temperature.

TABLE 1
Different Samples# Prepared for Experiment

| | Sample | | | | | | | |
|---|---|---|---|---|---|---|---|---|
| | E-1 | E-2 | E-3 | E-4 | E-5 | CE-1 | CE-2 | CE-3 |
| Description | Tyvek ® | Tyvek ® | Tyvek ® | Tyvek ® | Tyvek ® | Tyvek ® | Tyvek ® | Tyvek ® |
| | 1048A | 1048A | 1048A | 1048A | 1048A | 1048A | 1048A | 1048A |
| | coated | coated | coated | coated | coated | | coated | coated |
| | with 25 ppm | with 50 ppm | with 100 ppm | with 200 ppm | with 500 ppm | | with 100 ppm | with 100 ppm |
| | HFB II* | HFB | HFB | HFB | HFB | | BSA** | HFB II |
| | sloution | II sloution | II sloution | II sloution | II sloution | | sloution | sloution |

HFB II*—Hydrophobin Class II
BSA**—Bovine Serum Albumin
#Sample E-1, E-2, E-3, E-4, E-5, CE-1 and CE-2 was dried and heat treated wherein, sample CE-3 was dried and put under reduced pressure.

### Test Methods and Results

### Measurement of Water Contact Angle (WCA)

WCA of Tyvek® surface with or without coated protein layer were measured following Laplace Young Method using Contact Angle Goniometer (Drop shape analysis) Kruss DSA100 at ambient temperature. The measurements were based on water droplets of 5 microliters at 25° C.

Under the conditions disclosed herein, the aqueous amphiphilic protein solution used according to the disclosed process reduced the WCA by at least 15 to 75 degrees, compared to WCA of the polymeric surface coated with BSA and without any coating.

TABLE 2
WCA of Inkjet Printable Articles

| | Sample | | | | | | |
|---|---|---|---|---|---|---|---|
| | CE-1 | CE-2 | E-1 | E-2 | E-3 | E-4 | E-5 |
| WCA | 125 | 125 | 106 | 76 | 71 | 62 | 64 |

### Stability of Print Image

Stability of print images were monitored by immersing the printed polymeric surfaces in deionized water for 4 h and then evaluating optical micrograph of the print images using Nikon Stereo Microscope (SMZ 1000, Magnification, 10×).

Inkjet printable article prepared by coating 100 ppm of aqueous amphiphilic protein solution (E-3) retained the print image after being immersed in deionized water when tested after 4 h wherein, inkjet printable article without any protein coating (CE-1) and Inkjet printable article prepared by coating 100 ppm of aqueous BSA solution (CE-2), the print images disappeared after 4 h of being immersed in deionized water. The optical micrographs of the print images after dipping in deionized water are shown in FIG. 1.

### Weatherability Test

Polymeric surface without protein coating layer and coated with protein layer after printed with print image were exposed under fluorescent UV lamp for 100 h following ASTM G154 method using QUV Accelerated Weathering Tester available from Q-LAB Corporation, USA and taking optical micrograph of the exposed article using Nikon Stereo Microscope (SMZ 1000, Magnification, 10×).

Inkjet printable articles coated (E-3) retained the print image, as depicted in FIG. 2c and FIG. 2d wherein, for CE-1 the print image disappeared after weathering for 100 h, as depicted in FIG. 2a and FIG. 2b.

### Measurement of Line Width of Print Image by Optical Microscopy

Print quality on an inkjet printable surface was evaluated using optical microscopy and by measuring the line width of a print image. The line width of the print image is a measure of the average width of the border line of the print image, as depicted in FIG. 3.

Spreading or waviness of the print image along the border of the print impression on the matrix (inkjet printable article) resulted variations in line width in different locations. Spreading or waviness of the print impression (image) along the border and higher average value of line width of the print impression under identical print condition indicated spreading of ink on polymeric surface, slow drying and poor smudge resistance.

In the present invention, evaluation of line width of a print image ‘I’ (Font—Angsana New, Font size—28) was carried out by using the Nikon Stereo Microscope (Model-SMZ 1000, Magnification 10× and 20×) following a method described in the article entitled “The Importance of Objective Analysis in image Quality Evaluation” published in the proceedings of International Conference on Digital Printing Technologies, IS&Ts NIP 14: 1998. The dimension of image ‘I’ (Font—Angsana New, Font size—28) on paper (JK Papers, size-A4 (29.7 cm*21 cm), 75GSM grade) were width of head and tail 2200 micron, width of body 1000 micron and length 4290 micron, FIG. 3.

Inkjet printable articles coated with amphiphilic protein layer demonstrated improved quality of images, FIG. 4. Amphiphilic protein layer on polymeric surface, improved print quality as indicated by lowering spreading of initial impression of the print image with time, FIG. 4. Uncontrolled lateral flow of ink or irregularities of the image ‘I’ along the border was higher in CE-1 over E-3, FIG. 4. Further, lower values of average line width of the print image for samples E-1 to E-5 over CE-1, CE-2 and CE-3 indicated improved quality of print image, Table 3.

TABLE 3
Average Line Width of Print Image “I”

| | Sample | | | | | | | |
|---|---|---|---|---|---|---|---|---|
| | CE-1 | CE-2 | CE-3 | E-1 | E-2 | E-3 | E-4 | E-5 |
| Line | 2313 | 2483 | 2178 | 2013 | 1992 | 2031 | 2030 | 2033 |
| width, | | | | | | | | |
| μm | | | | | | | | |

### Color Measurement in ‘L’ Scale in Hunter L*, a*, b* Color Scale

Hunter L*, a*, b* Scale

Hunter L*, a*, b* scale is used for color measurement of any object and this color scale is based on the “Opponent-Color Theory”. The Hunter L*, a*, b* color organized is in a cube form as shown in FIG. 5 and perceives color as the following pairs of opposites. The ‘L’ scale runs from top to bottom. The maximum value of ‘L’ in the scale is 100 which would be a perfect reflection diffuser. Any value between 51 and 100 indicates relatively lighter color in intensity, wherein any value between 0 and 50 indicates relatively darker color in intensity. The minimum value of ‘L’ would be zero. The ‘a’ and ‘b’ axes have no specific numerical limits. Positive ‘a’ is red and negative ‘a’ is green. Positive ‘b’ is yellow and negative ‘b’ is blue.

LabScan XE

The color measurement of protein coated polymeric surface and polymeric surface without protein coating (circular dimension of 2.54 cm in dia) were covered with an ink composition comprising carbon black, 1,5-pentanediol, 2-pyrollidone and water were measured in ‘L’ scale using Labscan XE Spectrophotometer in the spectral range of 400 nm to 700 nm.

The measurement of color intensity of the ink color as a result of printing on the inkjet printable articles (polymeric surface coated with amphiphilic protein layer) showed a decrease of ‘L’ value in Hunter L*, a*, b* scale by at least 30, compared with the ‘L’ value of polymeric surface without coating with protein layer (control), Table 4.

TABLE 4
Color measurement in ‘L’ scale for inkjet printable article

| | | E-3 | E-4 | E-5 |
|---|---|---|---|---|
| | | (Polymeric | (Polymeric | (Polymeric |
| | CE-1 (control | layer | layer | layer |
| | without protein | with protein | with protein | with protein |
| Sample | coating) | coating) | coating) | coating) |
| ‘L’ value | 60.43 | 29.43 | 29.14 | 27.71 |

Absorption and spreading of ink inside the pores of the matrix present in polymeric surface, Tyvek® 1048A results higher ‘L’ value of CE-1 over E-3 where, coating of hydrophobin protein layer on Tyvek® resist penetration of ink inside the pores and assisted to hold ink on Tyvek® surface, FIG. 6.

1. An inkjet printable article, comprising a polymeric surface, coated on at least one side by an amphiphilic protein layer with a proviso that the water contact angle of the polymeric surface is ≧80° at 25° C.

2. The inkjet printable article of claim 1, wherein the amphiphilic protein layer is derived from an aqueous solution comprising at least one hydrophobin protein at a concentration range of about 10 ppm to about 1000 ppm.

3. The inkjet printable article of claim 2 wherein the hydrophobin protein is hydrophobin class II.

4. The inkjet printable article of claim 2 wherein the coating of the amphiphilic protein layer on the polymeric surface has a weight between about 0.002 g/m² and about 0.175 g/m², and more preferably between about 0.005 g/m² and about 0.10 g/m².

5. The inkjet printable article of claim 1, wherein the polymeric surface includes one or more polyolefin selected from the group of: high density polyethylene (HDPE); ultrahigh molecular weight polyethylene (UHMPE); linear low density polyethylene (LLDPE); ethylene copolymers; polypropylene (PP); and propylene copolymers.

6. The inkjet printable article of claim 1, wherein the water contact angle of the polymeric surface ranges between about 80° and about 140° at 25° C., and more preferably between about 100° and about 130° at 25° C.

7. The inkjet printable article of claim 5, wherein the polymeric surface comprises a membrane, film, tape, non-woven fabric, woven fabric or the like.

8. The inkjet printable article according to claim 2, wherein the aqueous solution further comprises additives such as UV stabilizer, light fastness imparting agent, dye mordant, thermal stabilizer, biocide, or a combination thereof.

9. A method of coating a polymeric surface with an amphiphilic protein layer comprising the steps;
a) providing an aqueous solution of an amphiphilic protein;
b) coating the polymeric surface with a solution of (a) at ambient temperature;
c) drying the article resulting from step (b) at ambient temperature till constant weight is obtained; and
d) treating the article resulting from step (c) by heating the article at a temperature in the range between about 60° C. to about 120° C. for 1 min to 120 min.

10. The method of claim 9, wherein the amphiphilic protein layer is derived from an aqueous solution comprising of at least one hydrophobin protein at a concentration ranges of about 10 ppm to about 1000 ppm.

11. The method of claim 10, wherein the amphiphilic protein layer comprises a hydrophobin class II protein.

12. The method of claim 9, wherein heat treatment is carried out in the temperature ranges between about 60° C. and about 120° C., and more preferably in the temperature ranges between about 80° C. and about 90° C.

13. The method of claim 9, wherein heat treatment is carried out between about 1 min and about 120 min, and more preferably between about 2 min and about 30 min.

14. The amphiphilic protein layer according to claim 10, wherein the coating weight of the amphiphilic protein layer on polymeric surface after drying is between about 0.002 g/m2 and about 0.175 g/m2, and more preferably between about 0.005 g/m² and about 0.10 g/m².

15. The method according to claim 9, wherein polymeric surface includes one or more polyolefin selected from the group consisting of high density polyethylene (HDPE), ultrahigh molecular weight polyethylene (UHMPE), linear low density polyethylene (LLDPE), ethylene copolymers, polypropylene (PP), and propylene copolymers.

16. The method according claim 9, wherein the water contact angle of the polymeric surface ranges between about 80° to about 140° at 25° C., and more preferably ranges between about 100° and about 130° at 25° C.

17. The method according to claim 15, wherein the polymeric surface comprises a membrane, film, tape, non-woven fabric, woven fabric and the like.

18. The method according to claim 10, wherein, the aqueous solution further comprises additives such as UV stabilizer, light fastness imparting agent, dye mordant, thermal stabilizer, biocide, or a combination thereof.

19. The printable article of claim 1 wherein the article is a inkjet printable surface selected from the likes of packaging materials; documents; labels; a bar code; clothing and garments; decoration or the like.
